(19) United States
(12) Patent Application Publication
(10) Pub. No.: US 2015/0308136 A1
(43) Pub. Date: Oct. 29, 2015

(54) HOTEL ROOM ACOUSTIC DOOR

(71) Applicant: Six Continents Hotels, Inc., Atlanta, GA (US)

(72) Inventors: Cori Kuechenmeister, Minneapolis, MN (US); Daniel Berg, St. Paul, MN (US); Meghan Hendrickson, Minneapolis, MN (US); Steve Haasl, Minneapolis, MN (US); Ashley Duale, Minneapolis, MN (US)

(21) Appl. No.: 14/605,812

(22) Filed: Jan. 26, 2015

Related U.S. Application Data
(60) Provisional application No. 61/983,426, filed on Apr. 23, 2014.

(51) Int. Cl. E04H 3/02; E06B 5/20; E06B 3/46

(52) U.S. Cl. CPC E04H 3/02; E06B 3/4636; E06B 5/20

(57) ABSTRACT

A hotel room includes a first area and a second area. The first area includes features to facilitate resting and/or working; the second area includes features that may produce noise or other distractions that are not conducive to resting and/or working. A hanging door can slide between the first and second areas to compartmentalize the resting and/or working area from the other area and reduce noise or distractions between the two areas.

### CROSS-REFERENCE TO RELATED APPLICATIONS

This application claims the benefit of U.S. Provisional Patent Application No. 61/983,426, filed Apr. 23, 2014, entitled “ACOUSTICAL DOOR,” which is incorporated herein by reference in its entirety.

### BACKGROUND

A hotel is an establishment that provides paid lodging on a short term basis. Hotels normally consist of a single or multiple buildings having multiple rooms in each building. The rooms are generally situated along shared corridors or other common spaces. Each room usually accommodates individual guests or a group of guests. Each room typically includes a bed, a bathroom, and other modern conveniences such as a desk, a television, and/or a refrigerator. However, a guest's enjoyment of features in a hotel room may be negatively affected by noise from other features or guests. In one common scenario, a guest may find it difficult to use the bed to sleep due to noise from a condenser of the refrigerator. In another common situation, a, guest may find it difficult to work at the desk due to noise from additional guests entering or exiting the room or passing by in the corridor outside the room. Such noise and distractions may cause a guest, to become dissatisfied with a hotel experience, which may result in complaints and/or lost business.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

According to at least one embodiment, a hotel includes a corridor and a room. The room includes an inner partition. An entry area on a first side of the inner partition includes an exit to the corridor. A sleeping area on a second, opposite side of the inner partition includes at least a bed. An opening through the inner partition provides passage between the entry area, and the sleeping area. An acoustic door slides between an open position and a closed position. The open position permits human passage between the entry area and the sleeping area via the opening. The closed position blocks human passage between the entry area and the sleeping area via the opening. The acoustic door includes a layer of sound-dampening material configured to reduce an amount of noise reaching the sleeping area from the corridor and/or the entry area when the acoustic door is in the closed position.

In accordance with some embodiments, a hotel room includes a first area of the room and a second area of the room. The second area adjoins the first area and includes a bed and a desk. A sliding partition is slidable between a first position and a second position. The first position compartmentalizes the first area of the room from the second area of the room, and in the second position, the first area and the second area are contiguous portions of a combined area.

In accordance with some embodiments, a hotel room includes an acoustic door, an inner partition, a first area on a first side of the inner partition, and a second area on a second, opposite side of the inner partition. The second area includes at least a bed. An opening through the inner partition provides passage between the first area and the second area. The acoustic door is configured to slide between: (i) a first position blocking passage between the first area and the second area via the opening so as to compartmentalize the first area of the room from the second area of the room, and (ii) a second position permitting passage between the first area and the second area via the opening such that the first area and the second area are contiguous portions of a combined area. The acoustic door includes a layer of sound-dampening material configured to reduce an amount of noise reaching the second area from the first area when the acoustic door is in the first position.

For a fuller understanding of the nature and advantages of the present invention, reference should be made to the ensuing detailed description and accompanying drawings.

### BRIEF DESCRIPTION OF THE DRAWINGS

FIG. 1 is a top diagrammatic view of an example of a hotel room having an acoustic door, in accordance with embodiments.

FIG. 2 is a top diagrammatic view of another example of a hotel room having an acoustic door, in accordance with embodiments.

FIG. 3 is a perspective view of an example of an acoustic door in a hotel room, in accordance with embodiments.

FIG. 4 is a side perspective view of the acoustic door of FIG. 3, in accordance with embodiments.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Embodiments herein are directed to an improved hotel room. The hotel room includes a first area for sleeping and/or working. The hotel room also includes a second area that may include equipment for storing and/or preparing food, an entrance to a bathroom, an entrance to an adjoining room, an exit from the room to a common space of the hotel, or some other feature or features that may produce noise or other distractions that are not conducive to sleeping and/or working. A hanging sliding door with sound-dampening material cars be positioned between the first and second areas to compartmentalize the sleeping and/or working area from the other area and reduce noise or distractions between the two areas.

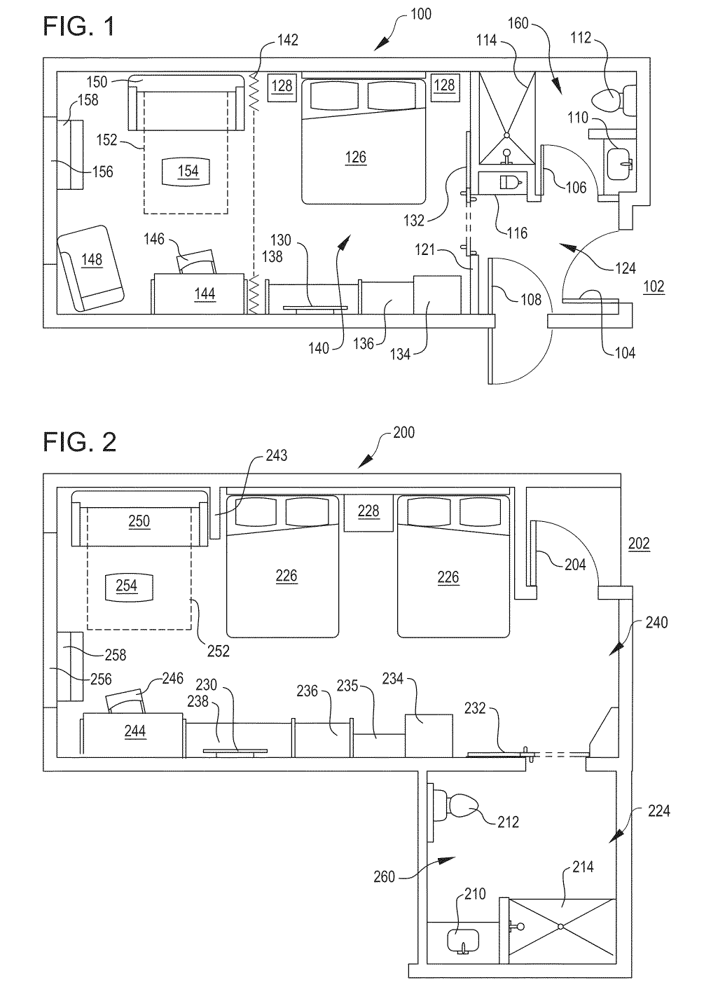

Referring now to the drawings, in which like reference numerals may represent like parts throughout the several views, FIG. 1 shows an example of an improved hotel room 100 having an acoustic door 132. The hotel room 100 includes a first area 124 and a second area 140 that are contiguous portions of a combined interior space of the hotel room 100. An inner partition 121 may provide a boundary or partial boundary between the first area 124 and the second area. 140. The inner partition 121 may include any arrangement of wall segments and/or gaps at a threshold between first area 124 and the second area 140, including, but not limited to, floor-to-ceiling wall segments, short wall segments (i.e., less than floor-to-ceiling), structural wall segments, decorative wall segments, wall segments corresponding to other areas (e.g., bounding a bathroom 160 and/or an alcove 116), floor-to-ceiling gaps, and/or short gaps (i.e., less than floor-to-ceiling). For example, the inner partition 121 may include a wall or portion of a wall through which a doorway or other passage joins the first area 124 to the second area 140. The acoustic door 132 may slide along one side of the inner partition 121 to complete the boundary between the first area 124 and the second area 140. For example, the acoustic door 132 may be positioned (such as depicted in phantom lines in FIG. 1) so as to block the doorway or other passage of the inner partition 121. Completing the boundary between the first area 124 and the second area 140 can compartmentalize the first area 124 from the second area 140. A guest may appreciate that the acoustic door 132 allows the guest to compartmentalize the hotel room 100 without completely sealing off the first area 124 from the second area 140, such as may otherwise occur with a door that might slain or otherwise snake significant amounts of noise or pressure changes in the process of closing. Indeed, the acoustic door 132 may traverse the entire open vertical distance of the passage through the partition 121, e.g., from the floor to a highest portion of the passage, substantially providing greater benefits than a typical door and avoiding the typical door's cost and noise disadvantages. Having the acoustic door 132 in the closed position, i.e., across the threshold between the first area 124 and the second area 140 (e.g., across a gap of the inner partition 121), may additionally or alternatively reduce an amount of sound that reaches the second area 140 from the first area 124.

The acoustic door 132 can provide compartmentalization and/or sound reduction between one or more features in the first area 124 and one or more features in the second area 140. A variety of such features are described herein, and embodiments can include any combination of such features, including embodiments in which one or more features are omitted, included fewer or more times than described or depicted, and/or located in the other of the first area 124 or the second area 140 than described or depicted.

In the particular embodiment depicted in FIG. 1, the first area 124 is an entryway into the hotel room 100. For example, the first area 124 has an exit door 104 providing egress between the hotel room 100 and a corridor 102 or other common space of the hotel, through which other hotel rooms, facilities, and amenities may be reached. The first area 124 of the hotel room 100 also includes a door 108 by which an adjacent room can be accessed. The door 108 is configured as a double door so that guests of each of the two rooms that share door 108 may independently decide whether to restrict access into either room from the adjacent room. The acoustic door 132 can thus reduce an amount of noise and/or visual distraction experienced by a guest in the second area 140 from other guests entering or exiting the room 100 via doors 108 or 104 or passing by in the corridor 102 outside.

The hotel room 100 also includes a bathroom 160 abutting the first area 124. A bathroom door 106 leads between the first area 124 and the bathroom 160 and may be shut to separate or isolate the bathroom 160 from the rest of the hotel room 100. The bathroom includes a sink 110, a toilet 112, and a shower stall 114, which may include a bathtub or a walk-in shower. The acoustic door 132 can thus reduce an amount of noise and/or visual distraction experienced by a guest in the second area 140 from other guests using the bathroom 160 or otherwise preparing for the day in the first area 124. The acoustic door 132 can also provide a guest in the first area 124 with an extra modicum of privacy, such as for getting dressed after exiting the bathroom 160.

The first area 124 also includes an alcove 116 having additional features that may cause auditory or visual distractions for guests in the second area 140 in the absence of the acoustic door 132. For example, the alcove 116 may include a refreshment station with food preparation or storage equipment that is likely to make noise during operation, such as a refrigerator, microwave, and/or coffee pot. In some embodiments, the alcove 116 may alternatively and/or additionally include other potentially noisy features, such as a sink, a desk, a telephone, a television, or a closet with hangers that may be noisy when accessed or utilized.

In the particular embodiment depicted in FIG. 1, the second area 140 is a larger “main” area in which a guest is likely to spend the bulk of his or her time during the hotel stay. Because the bulk of lime for most hotel guests will be spent either trying to rest or trying to be productive, the second area 140 primarily includes features that are likely to facilitate—or at minimum, not detract from—such objectives.

For example, the second area 140 includes a bed 126. A guest trying to rest by sleeping in the bed 126 may sleep better as a result of the acoustic door 132 reducing distractions or interruptions from features previously described with respect to the first area 124. Nightstands 128 placed on either side of the bed 126 can keep water, eyeglasses, clocks, or other items likely desired upon waking in easy reach of a guest. A guest may also choose to rest watching a television 130 and or by relaxing on another comfortable piece of furniture in the second area 140, such a sofa 150, a fold-out bed 152, or a chaise lounge 148. A coffee table 154, a dresser 138, a wardrobe 134, and a rack 136 in the second area 140 may also provide spaces for a guest's belongings for ease of access. An environmental control unit 158 (such as a combined heater and air conditioner) can allow the guest to adjust a temperature of the room to a desired level. A sliding glass door or window 156 may further assist in temperature control and or can provide an enjoyable view and or access to a balcony.

The second area 140 also includes a desk 144 and chair 146. A guest can thus use the second area 140 to work without distractions or interruptions from features previously described with respect to the first area 124. The second area 140 also includes a divider curtain 142 that a guest can use to distinguish the working area with the desk 144 from the sleeping area with the bed 126.

FIG. 2 shows another example of an improved hotel room 200 having an acoustic door 232, In the particular embodiment depicted in FIG. 2, the first area 224 is a bathroom 260 having a sink 210, a toilet 212, and a shower stall 214. The second area includes an entry door 204 from a corridor 202, two beds 226, a nightstand 228, a sofa 250, a folding bed 252, a coffee table 254, a window or sliding glass door 256, an environmental control unit 258, desk 244, chair 246, dresser 238, television 230, rack 236, shelf 235, and wardrobe 234. The acoustic door 232 can provide compartmentalization and/or sound reduction between one or more features in a first area 224 and one or more features in a second area 240.

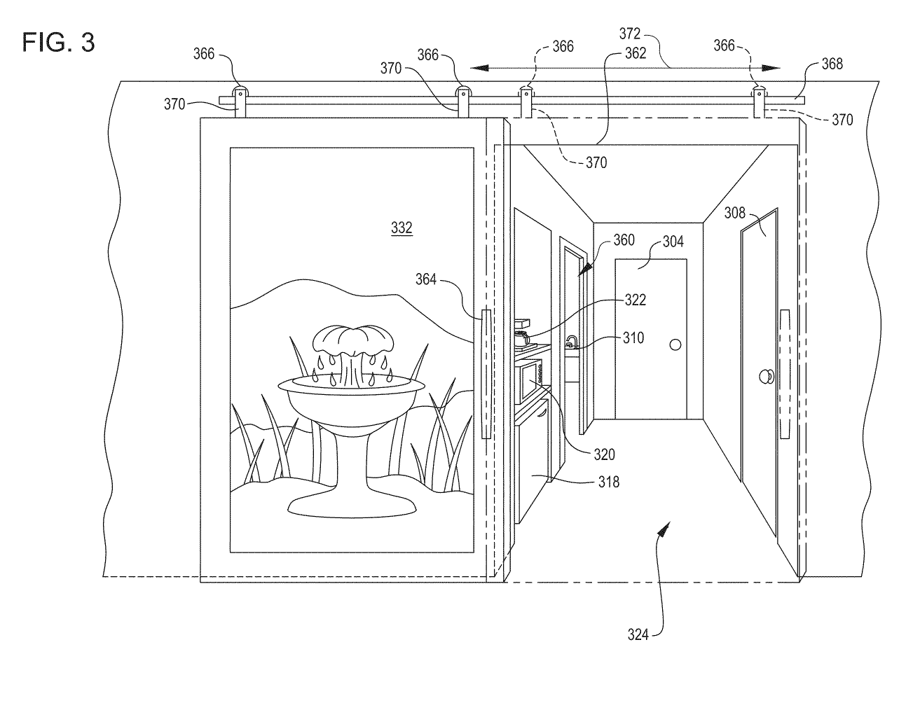

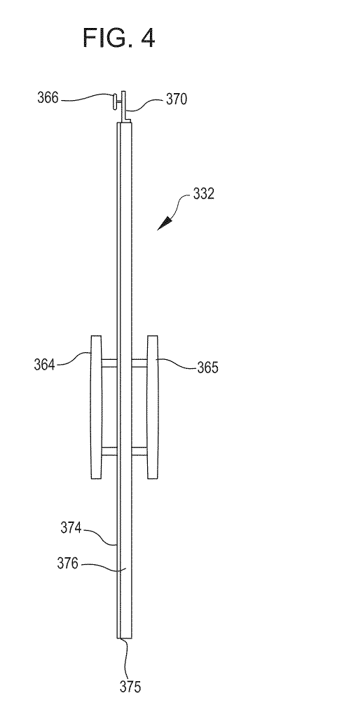

FIGS. 3 and 4 are respectively a perspective view arid a side view of an example of an acoustic door 332. The acoustic door 332 may correspond to another acoustic door previously described, such as the acoustic door 132 of FIG. 1. To this end, the perspective provided in FIG. 3 corresponds to a view looking from the second area 140 toward the first area 124 described above with respect to FIG. 1.

The acoustic door 332 is suspended from a rail 368 above the acoustic door 332 and attached to an outer face of a wall or partition in a hotel room. One or more supports 370 at a top of the acoustic door 332 join rollers 366 to the acoustic door 332. The rollers 366 engage the rail 368 so that the acoustic door 332 may slide along the partition.

The acoustic door 332 includes a body panel 376 and an acoustic panel 374 (FIG. 4). The acoustic panel 376 can be decorated to serve a dual function as art in the hotel room (FIG. 3). The acoustic door 332 can also include handles 364 and 365 (FIG. 4) on either side of the acoustic door 332 so as to facilitate sliding the acoustic door 332 from either side. In a first position (e.g., depicted in solid lines in FIG. 3), the acoustic door 332 can provide access to a first area 324; in a second position (e.g., depicted in phantom lines in FIG. 3), the acoustic door 332 can compartmentalize off the first area 324 and/or reduce sound passing through the acoustic door 332.

The acoustic panel 374 can include one or more layers of material configured to reduce sound passage by a variety of factors, for example, according to a level specified by a hotel operator such as 30 percent, 50 percent, or 95 percent. In some aspects, a sound reduction factor may be based on a thickness of the acoustic panel 374 and/or a size of a gap between the acoustic panel 374 and the body panel 376. As a first illustrative example, the acoustic panel 374 may include a panel having a thickness of 0.79 centimeter (0.31 inches) (such as is sold under the trade name “ecoustic panel” from Unika Vaev). This particular acoustic panel 374 may be directly affixed to the door panel 374 to provide a sound reduction factor of 30 percent. Alternatively, this particular acoustic panel 374 may be affixed with a 1.40 centimeters (0.55 inch) air gap between the door panel 374 and the acoustic panel 374 to provide a sound reduction factor of 40 percent, affixed with air gaps of 2.39 centimeters (0.94 inch) or 5.00 centimeters (1.97 inch) to respectively provide sound reduction factors of 45 percent and 55 percent, or affixed with some other size air gap to otherwise vary the sound reduction factor provided. As a second illustrative example, the acoustic door panel 374 may be directly attached to an acoustic panel 374 having an “ecoustic panel” of 5.00 centimeters (1.97 inch) thickness to provide a noise reduction factor of 95 percent. Thicknesses, arrangements, and suppliers other than those listed in these illustrative examples may alternatively provide suitable sound reduction factors. Thus, referring again to the example depicted in FIG. 3, the acoustic door 332 can reduce (in some examples, by a factor of up to 95 percent) noise corning from the door 308 to an adjacent room, the exit door 304, the sink 310 or other fixtures in the bathroom 360, and/or features of a refreshment station (such as a coffee maker 322, microwave 320, and/or refrigerator 318).

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form, or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A hotel comprising:
a corridor; and
a room comprising:
an inner partition;
an entry area on a first side of the inner partition, the entry area comprising an exit to the corridor;
a sleeping area on a second, opposite side of the inner partition, the sleeping area comprising at least a bed;
an opening through the inner partition and providing passage between the entry area and the sleeping area;
an acoustic door located in the sleeping area and configured to slide along a surface of the inner partition that faces the sleeping area so as to slide between (i) an open position permitting human passage between the entry area and the sleeping area via the opening and (ii) a closed position blocking human passage between the entry area and the sleeping area via the opening, the acoustic door comprising a layer of sound-dampening material configured to reduce an amount of noise reaching the sleeping area from the corridor and/or from the entry area when the acoustic door is in the closed position.

2. The hotel of claim 1, wherein the entry area further comprises a doorway to a bathroom and the sound-dampening material of the acoustic door is configured to reduce an amount of noise reaching the sleeping area from the bathroom and/or from the entry area.

3. The hotel of claim 2, wherein the entry area further comprises a refreshment area comprising at least one of a refrigerator, a microwave, or a coffee maker, and wherein the sound-dampening material of the acoustic door is configured to reduce an amount of noise reaching the sleeping area from the refreshment area and/or from the entry area.

4. The hotel room of claim 3, wherein the sleeping area further comprises a workstation comprising a desk and a chair.

5. The hotel of claim 1, wherein the acoustic door comprising the layer of sound-dampening material is configured to reduce the amount of noise reaching the sleeping area from the corridor and/or from the entry area by at least 30 percent.

6. The hotel of claim 5, wherein the acoustic door comprising the layer of sound-dampening material is configured to reduce the amount of noise reaching the sleeping area from the corridor and/or from the entry area by at least 50 percent.

7. The hotel of claim 6, wherein the acoustic door comprising the layer of sound-dampening material is configured to reduce the amount of noise reaching the sleeping area from the corridor and/or from the entry area by at least 95 percent.

8. The hotel of claim 7, wherein the layer of sound-dampening material is mounted on a side of the acoustic door that faces the sleeping area.

9. The hotel of claim 8, wherein the layer of sound-dampening material is offset from a panel of the acoustic door panel by a gap so as to increase an amount of noise reduction provided by the acoustic door.

10. The hotel of claim 1, wherein the inner partition further comprises a rail positioned above and supporting the acoustic door, wherein the acoustic door comprises one or more rollers engaging the rail, wherein the acoustic door is slidable as a result of the one or more rollers engaging the rail.

11. A hotel room comprising:
a first area of the room;
a second area of the room, the second area adjoining the first area and comprising a bed and a desk;
a wall forming at least a portion of a boundary of the second area; and
a sliding partition located in the second area and slidable along a surface of the wall that faces the second area so as to slide between (i) a first position compartmentalizing the first area of the room from the second area of the room and (ii) a second position in which the first area and the second area are contiguous portions of a combined area.

12. The hotel room of claim 11, wherein the sliding partition comprises a layer of sound-dampening material configured to reduce an amount of noise reaching the second area from the first area.

13. The hotel room of claim 11, wherein the first area comprises an entry area comprising an exit from the room.

14. The hotel room of claim 11, wherein the first area comprises a bathroom or an area comprising an entrance to a bathroom.

15. The hotel room of claim 11, wherein the first area comprises a refreshment area comprising at least one of a refrigerator, a microwave, or a coffee maker.

16. The hotel room of claim 11, wherein the first area comprises an entertainment area comprising a television.

17. The hotel room of claim 11, wherein a layer of sound-dampening material is configured to reduce the amount of noise reaching the sleeping area from the corridor by at least 30 percent.

18. A hotel room comprising:
an inner partition;
a first area on a first side of the inner partition;
a second area on a second, opposite side of the inner partition, the second area comprising at least a bed;
an opening through the inner partition and providing passage between the first area and the second area;
an acoustic door located in the second area and configured to slide along a surface of the inner partition that faces the second area so as to slide between:
(i) a first position blocking passage between the first area and the second area via the opening so as to compartmentalize the first area of the room from the second area of the room, and
(ii) a second position permitting passage between the first area and the second area via the opening such that the first area and the second area are contiguous portions of a combined area, the acoustic door comprising a layer of sound-dampening material configured to reduce an amount of noise reaching the second area from the first area when the acoustic door is in the first position.

19. The hotel room of claim 18, wherein the first area comprises at least one of:
an entry area comprising an exit from the room;
a bathroom or an area comprising an entrance to a bathroom;
a refreshment area comprising at least one of a refrigerator, a microwave, or a coffee maker;
a workstation comprising a desk and a chair; or
an entertainment area comprising a television.

20. The hotel room of claim 18, wherein the second area further comprises at least one of:
a seating area;
a wardrobe;
a workstation comprising a desk and a chair; or
a television.
